(19) United States
(12) Patent Application Publication
(10) Pub. No.: US 2024/0060349 A1
(43) Pub. Date: Feb. 22, 2024

(54) HOUSEHOLD APPLIANCE AND DOOR ASSEMBLY

(71) Applicant: WHIRLPOOL CORPORATION, Benton Harbor, MI (US)

(72) Inventors: VENKATESH G. AJARI, MAHARASHTRA (IN); MOHSIN MAHAMADSHAFI ATTAR, MAHARASHTRA (IN); MARCUS R. FISCHER, STEVENSVILLE, MI (US); KURT L. MASCIOVECCHIO, SAINT JOSEPH, MI (US); AJIKET JITENDRASINGH PATIL, MAHARASHTRA (IN); MICHAEL VRIEZEMA, SAINT JOSEPH, MI (US)

(21) Appl. No.: 17/891,298

(22) Filed: Aug. 19, 2022

(51) Int. Cl. E05F 15/53; D06F 39/14

(52) U.S. Cl. CPC E05F 15/53; D06F 39/14; E05Y 2201/456; E05Y 2900/312

(57) ABSTRACT

A door assembly and laundry treating appliance with a door assembly can include a door selectively closing an open face defined by a chassis. A hinge can be mounted to the door and define a first rotation axis. An actuator can be operably coupled to the hinge and define a rotational motion path to rotate the door about the first rotation axis.

### BACKGROUND

Household appliances, including laundry treating appliances such as washing machines, combination washer/dryers, refreshers, and non-aqueous systems, can have a configuration based on a treating chamber in which items are placed for treating. The laundry treating appliance can have a controller that implements a number of user-selectable, pre-programmed cycles of operation having one or more operating parameters. Hot water, cold water, or a mixture thereof, along with various treating chemistries, can be supplied to the treating chamber in accordance with the cycle of operation. In addition, hot air, cold air, or a mixture thereof can be supplied to the treating chamber in accordance with the cycle of operation and via an air flow assembly.

In some exemplary implementations, household appliances can include an inner door selectively providing access to an interior space, and an outer aesthetic door covering the inner door. Such appliances can include one or more hinges for opening the outer and inner doors.

### BRIEF SUMMARY

In one aspect, the disclosure relates to a door assembly for closing an open face defined by a chassis. The door assembly includes a door selectively closing the open face, a hinge mounted to the door and defining a first rotation axis, a first actuator operably coupled to the hinge and defining a rotational motion path to rotate the door about the first rotation axis; and a second actuator operably coupled to the hinge and defining a translational motion path, wherein the hinge is movable along the translational motion path when the door is rotated about the first rotation axis.

In another aspect, the disclosure relates to a household appliance. The household appliance includes a chassis defining an interior with an open face, and a door assembly coupled to the chassis and including a door movable between open and closed positions, with the door closing the open face when in the closed position, a first rotation axis defined along the door, and an actuator assembly operably coupled to the door, the actuator assembly defining a rotational motion path to rotate the door about the first rotation axis, and also defining a translational motion path to shift the rotational motion path in at least a linear direction.

In yet another aspect, the disclosure relates to a household appliance. The household appliance includes a chassis defining an interior with an open face, a door selectively closing the open face, a hinge mounted to the door and defining a rotation axis, a first actuator operably coupled to the hinge and operable between first and second positions to rotate the door about the rotation axis, and a second actuator operably coupled to the hinge and operable between non-translated and translated positions, where, in the translated position, the hinge is translated at least one of laterally or away from the chassis.

### BRIEF DESCRIPTION OF THE DRAWINGS

In the drawings:

FIG. 1 is a schematic cross-sectional view of an exemplary household appliance in the form of a laundry treating appliance in accordance with various aspects described herein.

FIG. 2 is a schematic diagram of a control system of the laundry treating appliance of FIG. 1.

FIG. 3 is a top cross-sectional view of the laundry treating appliance of FIG. 1 illustrating a door assembly in accordance with various aspects described herein.

FIG. 4 is a schematic top view of the door assembly of FIG. 3 in a closed position.

FIG. 5 is a schematic diagram of an actuator assembly in the door assembly of FIG. 3 in accordance with various aspects described herein.

FIG. 6 is a schematic top view of the door assembly of FIG. 3 in an intermediate position.

FIG. 7 is a schematic top view of the door assembly of FIG. 3 in a fully-open position.

FIG. 8 is a perspective view of the door assembly of FIG. 3 in the intermediate position of FIG. 5.

FIG. 9 is a perspective view of the door assembly of FIG. 3 in the fully-open position of FIG. 7.

FIG. 10 is a schematic top view of another door assembly that can be utilized with the household appliance of FIG. 1 in accordance with various aspects described herein, and in a closed position.

FIG. 11 is a schematic view of a rotatable linkage in the door assembly of FIG. 10.

FIG. 12 is a schematic top view of the door assembly of FIG. 10 in an intermediate position.

FIG. 13 is a schematic top view of the door assembly of FIG. 10 in a fully-open position.

FIG. 14 is a schematic diagram of an actuator assembly in the door assembly of FIG. 10 in accordance with various aspects described herein.

### DETAILED DESCRIPTION

Aspects of the present disclosure generally relate to a door assembly. In some implementations, household appliances, cabinets, or the like can include an overlapping-door arrangement wherein an inner “functional” door closes an interior space, and an outer “aesthetic” door overlies the inner door to form an exterior surface of the appliance or cabinet. Use of an outer door can provide a customizable aesthetic appearance, for example, where the inner door can include other functional elements such as a projecting handle, sealing components, or the like. Access to the interior space in such appliances can involve first opening the outer/aesthetic door and then opening the inner door. For aesthetic purposes, the hinges of each door should be closely spaced together or co-arranged on a common hinge such that little to no gap exists between the doors and surrounding frame when closed. However, a maximum opening angle of the inner door can be undesirably limited, for example due to “pinch points” where the outer door abuts the inner door when both are fully opened.

Aspects of the disclosure provide for a door assembly with a movable hinge, such that the inner door can shift or move along at least one motion path during opening and closing. The described aspects provide for an improved maximum opening angle, in one example providing nearly 30% more range of motion in opening angle compared to a traditional dual-door arrangement, while preserving a desired aesthetic appearance and minimal gaps with the cabinet when both doors are closed. In one example, an actuator assembly can provide multiple motion paths to shift the inner door and hinge away from the cabinet during opening. In another example, an actuator assembly can provide multiple motion paths to shift the inner door and hinge at least laterally along the cabinet during opening.

For the purposes of illustration, the present disclosure will be described in terms of a household appliance such as a combination laundry washer/dryer. It is understood that the disclosure is not so limited, and aspects described herein have general applicability in a variety of door assemblies and household appliances including, but not limited to, free-standing cabinets, laundry treating appliances, dishwashers, refrigerators, freezers, or the like. Some non-limiting examples of laundry treating appliances include laundry washing appliances, laundry drying appliances, combination laundry washer/dryers, refreshing/revitalizing machines, extractors, non-aqueous washing apparatuses, or the like.

Washing machines are typically categorized as either a vertical axis washing machine or a horizontal axis washing machine. The terms “vertical axis” and “horizontal axis” are often used as shorthand terms for the manner in which the appliance imparts mechanical energy to the load of laundry, even when the relevant rotational axis is not absolutely vertical or horizontal. As used herein, the “vertical axis” washing machine refers to a washing machine having a rotatable drum, perforate or imperforate, that holds fabric items and a clothes mover, such as an agitator, impeller, nutator, and the like within the drum. The clothes mover moves within the drum to impart mechanical energy directly to the clothes or indirectly through wash liquid in the drum. The clothes mover can typically be moved in a reciprocating rotational movement. In some vertical axis washing machines, the drum rotates about a vertical axis generally perpendicular to a surface that supports the washing machine. However, the rotational axis need not be vertical. The drum can rotate about an axis inclined relative to the vertical axis.

As used herein, the “horizontal axis” washing machine refers to a washing machine having a rotatable drum, perforated or imperforate, that holds laundry items and washes the laundry items. In some horizontal axis washing machines, the drum rotates about a horizontal axis generally parallel to a surface that supports the washing machine. However, the rotational axis need not be horizontal. The drum can rotate about an axis inclined or declined relative to the horizontal axis. In horizontal axis washing machines, the clothes are lifted by the rotating drum and then fall in response to gravity to form a tumbling action. Mechanical energy is imparted to the clothes by the tumbling action formed by the repeated lifting and dropping of the clothes. Vertical axis and horizontal axis machines are best differentiated by the manner in which they impart mechanical energy to the fabric articles.

Regardless of the axis of rotation, a washing machine can be top-loading or front-loading. In a top-loading washing machine, laundry items are placed into the drum through an access opening in the top of a cabinet, while in a front-loading washing machine laundry items are placed into the drum through an access opening in the front of a cabinet. If a washing machine is a top-loading horizontal axis washing machine or a front-loading vertical axis washing machine, an additional access opening is located on the drum.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Connection references (e.g., attached, coupled, connected, or joined) are to be construed broadly and can include intermediate members between a collection of elements and relative movement between elements unless otherwise indicated. As such, connection references do not necessarily infer that two elements are directly connected and in fixed relation to one another. Furthermore, as used herein, the term “set” or a “set” of elements can be any number of elements, including only one. The exemplary drawings are for purposes of illustration only and the dimensions, positions, order and relative sizes reflected in the drawings attached hereto can vary.

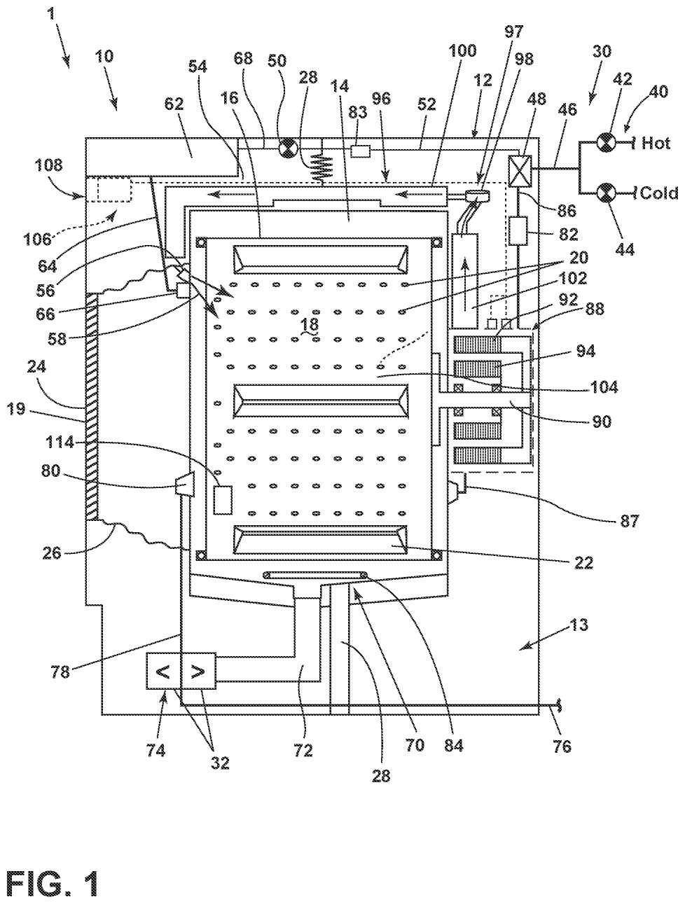

FIG. 1 is a schematic cross-sectional view of an exemplary household appliance 1. In the illustrated example, the exemplary household appliance 1 is shown as a horizontal axis, front-load combination washing and drying machine 10 though this need not be the case. The household appliance 1 can be any household appliance, including a horizontal-axis or vertical-axis clothes washer, a combination washing machine and dryer, a clothes dryer, a tumbling or stationary refreshing/revitalizing machine, an extractor, a non-aqueous washing apparatus, a dishwasher, a refrigerator or freezer, or the like, in some non-limiting examples.

The combination washing and drying machine 10 can include a structural support system including a cabinet or chassis 12. The chassis 12 can include a housing defining an interior 13. The chassis 12 can enclose components typically found in a conventional washing machine, such as motors, pumps, fluid lines, controls, sensors, transducers, and the like. Such components will not be described further herein except as necessary for a complete understanding of the present disclosure.

The chassis 12 can define a housing within which a laundry holding system resides. Such a laundry holding system can include a tub 14 dynamically suspended within the structural support system of the chassis 12 by a suitable suspension system 28 and a drum 16 provided within the tub 14. The tub 14 can define at least a portion of a treating chamber 18. For example, the treating chamber 18 can be located within the drum 16. The treating chamber 18 can have an access opening 19. The drum 16 can be configured to receive a laundry load through the access opening 19 with articles for treatment, including, but not limited to, a hat, a scarf, a glove, a sweater, a blouse, a shirt, a pair of shorts, a dress, a sock, and a pair of pants, a shoe, an undergarment, and a jacket. The drum 16 can include a plurality of perforations 20 such that liquid can flow between the tub 14 and the drum 16 through the perforations 20. It is also within the scope of the present disclosure for the laundry holding system to include only one receptacle with the receptacle defining the laundry treating chamber for receiving the load to be treated. At least one lifter 22 can extend from a wall of the drum 16 to lift the laundry load received in the treating chamber 18 while the drum 16 rotates.

The laundry holding system can further include a closure 24 which can be movably mounted to the chassis 12 to selectively close both the tub 14 and the drum 16. In the example shown, the closure 24 is in the form of a door assembly 25 positioned on the front of the chassis 12. In some examples, the closure 24 or door assembly 25 can include a lid, panel, viewing window, or the like. A bellows 26 can couple an open face of the tub 14 with the chassis 12, with the closure 24 sealing against the bellows 26 when the closure 24 is in the closed position.

The combination washing and drying machine 10 can further include a washing circuit 30 having at least one wash circuit component 32 located within the chassis 12. The at least one wash circuit component 32 can include a liquid supply system for supplying water to the combination washing and drying machine 10 for use in treating laundry during a cycle of operation. The liquid supply system can include a source of water, such as a household water supply 40, which can include separate valves 42 and 44 for controlling the flow of hot and cold water, respectively. Water can be supplied through an inlet conduit 46 directly to the tub 14 or the drum 16 by controlling first and second diverter mechanisms 48 and 50, respectively. The diverter mechanisms 48, 50 can be a diverter valve having two outlets such that the diverter mechanisms 48, 50 can selectively direct a flow of liquid to one or both of two flow paths. Water from the household water supply 40 can flow through the inlet conduit 46 to the first diverter mechanism 48 which can direct the flow of liquid to a supply conduit 52. The second diverter mechanism 50 on the supply conduit 52 can direct the flow of liquid to a tub outlet conduit 54 which can be provided with a spray nozzle 56 configured to spray the flow of liquid 58 into the tub 14. In this manner, water from the household water supply 40 can be supplied directly to the tub 14. While the valves 42, 44 and the inlet conduit 46 are illustrated exteriorly of the chassis 12, it will be understood that these components can be internal to the chassis 12.

The combination washing and drying machine 10 can also be provided with a dispensing system for dispensing treating chemistry to the treating chamber 18 for use in treating the load of laundry according to a cycle of operation. The dispensing system can include a treating chemistry dispenser 62 which can be a single dose dispenser, a bulk dispenser, or an integrated single dose and bulk dispenser and is fluidly coupled to the treating chamber 18. The treating chemistry dispenser 62 can be configured to dispense a treating chemistry directly to the tub 14 or mixed with water from the liquid supply system through a dispensing outlet conduit 64. The dispensing outlet conduit 64 can include a dispensing nozzle 66 configured to dispense the treating chemistry into the tub 14 in a desired pattern and under a desired amount of pressure. For example, the dispensing nozzle 66 can be configured to dispense a flow or stream of treating chemistry into the tub 14 by gravity, i.e. a non-pressurized stream. Water can be supplied to the treating chemistry dispenser 62 from the supply conduit 52 by directing the diverter mechanism 50 to direct the flow of water to a dispensing supply conduit 68.

The treating chemistry dispenser 62 can include multiple chambers or reservoirs for receiving doses of different treating chemistries. The treating chemistry dispenser 62 can be implemented as a dispensing drawer that is slidably received within the chassis 12, or within a separate dispenser housing which can be provided in the chassis 12. The treating chemistry dispenser 62 can be moveable between a fill position, where the treating chemistry dispenser 62 is exterior to the chassis 12 and can be filled with treating chemistry, and a dispense position, where the treating chemistry dispenser 62 are interior of the chassis 12.

Non-limiting examples of treating chemistries that can be dispensed by the dispensing system during a cycle of operation include one or more of the following: water, enzymes, fragrances, stiffness/sizing agents, wrinkle releasers/reducers, softeners, antistatic or electrostatic agents, stain repellants, water repellants, energy reduction/extraction aids, antibacterial agents, medicinal agents, vitamins, moisturizers, shrinkage inhibitors, and color fidelity agents, and combinations thereof.

The combination washing and drying machine 10 can also include a recirculation and drain system for recirculating liquid within the laundry holding system and draining liquid from the combination washing and drying machine 10. Liquid supplied to the tub 14 through tub outlet conduit 54 and/or the dispensing supply conduit 68 typically enters a space between the tub 14 and the drum 16 and can flow by gravity to a sump 70 formed in part by a lower portion of the tub 14. The sump 70 can also be formed by a sump conduit 72 that can fluidly couple the lower portion of the tub 14 to a pump 74. The pump 74 can direct liquid to a drain conduit 76, which can drain the liquid from the combination washing and drying machine 10, or to a recirculation conduit 78, which can terminate at a recirculation inlet 80. The recirculation inlet 80 can direct the liquid from the recirculation conduit 78 into the drum 16. The recirculation inlet 80 can introduce the liquid into the drum 16 in any suitable manner, such as by spraying, dripping, or providing a steady flow of liquid. In this manner, liquid provided to the tub 14, with or without treating chemistry can be recirculated into the treating chamber 18 for treating the load of laundry within.

The liquid supply and/or recirculation and drain system can be provided with a heating system which can include one or more devices for heating laundry and/or liquid supplied to the tub 14, such as a steam generator 82, an inline heater 83 and/or a sump heater 84. Liquid from the household water supply 40 can be provided to the steam generator 82 through the inlet conduit 46 by controlling the first diverter mechanism 48 to direct the flow of liquid to a steam supply conduit 86. Steam generated by the steam generator 82 can be supplied to the tub 14 through a steam outlet conduit 87. The steam generator 82 can be any suitable type of steam generator such as a flow through steam generator or a tank-type steam generator. Alternatively, the sump heater 84 can be used to generate steam in place of or in addition to the steam generator 82. In addition or alternatively to generating steam, the steam generator 82 and/or sump heater 84 can be used to heat the laundry and/or liquid within the tub 14 as part of a cycle of operation.

It is noted that the illustrated suspension system, liquid supply system, recirculation and drain system, and dispensing system are shown for exemplary purposes only and are not limited to the systems shown in the drawings and described above. For example, the liquid supply, dispensing, and recirculation and pump systems can differ from the configuration shown in FIG. 1, such as by inclusion of other valves, conduits, treating chemistry dispensers, sensors, such as water level sensors and temperature sensors, and the like, to control the flow of liquid through the combination washing and drying machine 10 and for the introduction of more than one type of treating chemistry. For example, the liquid supply system can include a single valve for controlling the flow of water from the household water source. In another example, the recirculation and pump system can include two separate pumps for recirculation and draining, instead of the single pump as previously described.

The combination washing and drying machine 10 can also include a drive system for rotating the drum 16 within the tub 14. The drive system can include a motor 88, which can be directly coupled with the drum 16 through a drive shaft 90 to rotate the drum 16 about a rotational axis during a cycle of operation. The motor 88 can be a brushless permanent magnet (BPM) motor having a stator 92 and a rotor 94. Alternately, the motor 88 can be coupled to the drum 16 through a belt and a drive shaft to rotate the drum 16, as is known in the art. Other motors, such as an induction motor or a permanent split capacitor (PSC) motor, can also be used. The motor 88 can rotate the drum 16 at various speeds in either rotational direction.

The motor 88 can rotate the drum 16 at various speeds in opposite rotational directions. In particular, the motor 88 can rotate the drum 16 at tumbling speeds wherein the fabric items in the drum 16 rotate with the drum 16 from a lowest location of the drum 16 towards a highest location of the drum 16, but fall back to the lowest location of the drum 16 before reaching the highest location of the drum 16. The rotation of the fabric items with the drum 16 can be facilitated by the at least one lifter 22. Typically, the force applied to the fabric items at the tumbling speeds is less than about 1G. Alternatively, the motor 88 can rotate the drum 16 at spin speeds wherein the fabric items rotate with the drum 16 without falling. The spin speeds can also be referred to as satellizing speeds or sticking speeds. Typically, the force applied to the fabric items at the spin speeds is greater than or about equal to 1G. As used herein, “tumbling” of the drum 16 refers to rotating the drum at a tumble speed, “spinning” the drum 16 refers to rotating the drum 16 at a spin speed, and “rotating” of the drum 16 refers to rotating the drum 16 at any speed.

The combination washing and drying machine 10 can also include a drying circuit 96. The drying circuit 96 can include a closed-loop or an open-loop circuit. The drying circuit 96 can have at least one drying circuit component 97 located within the chassis 12. The at least one drying circuit component 97 can include an air recirculation conduit that is fluidly coupled to and recirculates air 104 through the treating chamber 18. The air recirculation conduit can include a blower 98 and a heating element 102. In some examples, a condenser 100 can also be provided. In such a case, the condenser 100 can be provided with a condenser drain conduit (not shown in FIG. 1) that fluidly couples the condenser 100 with the pump 74 and the drain conduit 76. Condensed liquid collected within the condenser 100 can flow through the condenser drain conduit to the pump 74, where it can be provided to the recirculation and drain system. While the drying circuit 96 is shown adjacent an upper portion of the tub 14, it will be understood that the disclosure is not so limited and the drying circuit 96 can be provided at any suitable location within the chassis 12. In some examples, the drying circuit 96 can provide drying air 104 into the treating chamber 18 via the perforations 20 for drying the laundry items. In some examples, an open loop circuit can be implemented where air is heated by the heating element 102, passed through the drum 16, and exhausted out of the combination washing and drying machine 10.

The combination washing and drying machine 10 can also include a control system for controlling the operation of the combination washing and drying machine 10 to implement one or more cycles of operation. The control system can include a controller 106 located within the chassis 12 and a user interface 108 that is operably coupled with the controller 106. The user interface 108 can include one or more knobs, dials, switches, displays, touch screens and the like for communicating with the user, such as to receive input and provide output. The user can enter different types of information including, without limitation, cycle selection and cycle parameters, such as cycle options.

The controller 106 can include the machine controller and any additional controllers provided for controlling any of the components of the washing machine 10. For example, the controller 106 can include the machine controller and a motor controller. Many known types of controllers can be used for the controller 106. It is contemplated that the controller is a microprocessor-based controller that implements control software and sends/receives one or more electrical signals to/from each of the various working components to effect the control software. As an example, proportional control (P), proportional integral control (PI), and proportional derivative control (PD), or a combination thereof, a proportional integral derivative control (PID control), can be used to control the various components.

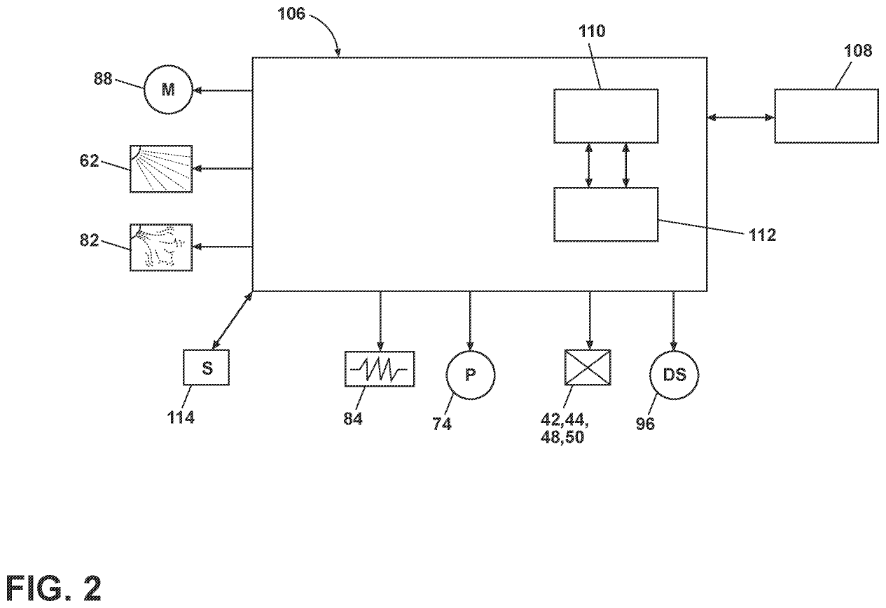

As illustrated in FIG. 2, the controller 106 can be provided with a memory 110 and a central processing unit (CPU) 112. The memory 110 can be used for storing the control software that is executed by the CPU 112 in completing a cycle of operation using the combination washing and drying machine 10 and any additional software. Examples, without limitation, of cycles of operation include: wash, heavy duty wash, delicate wash, quick wash, pre-wash, refresh, rinse only, and timed wash. The memory 110 can also be used to store information, such as a database or table, and to store data received from one or more components of the combination washing and drying machine 10 that can be communicably coupled with the controller 106. The database or table can be used to store the various operating parameters for the one or more cycles of operation, including factory default values for the operating parameters and any adjustments to them by the control system or by user input.

The controller 106 can be operably coupled with one or more components of the combination washing and drying machine 10 for communicating with and controlling the operation of the component to complete a cycle of operation. For example, the controller 106 can be operably coupled with the motor 88, the pump 74, the treating chemistry dispenser 62, the steam generator 82, the sump heater 84, and the drying circuit 96 to control the operation of these and other components to implement one or more of the cycles of operation.

The controller 106 can also be coupled with one or more sensors 114 provided in one or more of the systems of the washing machine 10 to receive input from the sensors, which are known in the art and illustrated in FIG. 1 in a lower portion of the treating chamber 18 for exemplary purposes only. Non-limiting examples of sensors 114 that can be communicably coupled with the controller 106 include: a treating chamber temperature sensor, a moisture sensor, a weight sensor, a chemical sensor, a position sensor and a motor torque sensor, which can be used to determine a variety of system and laundry characteristics, such as laundry load inertia or mass.

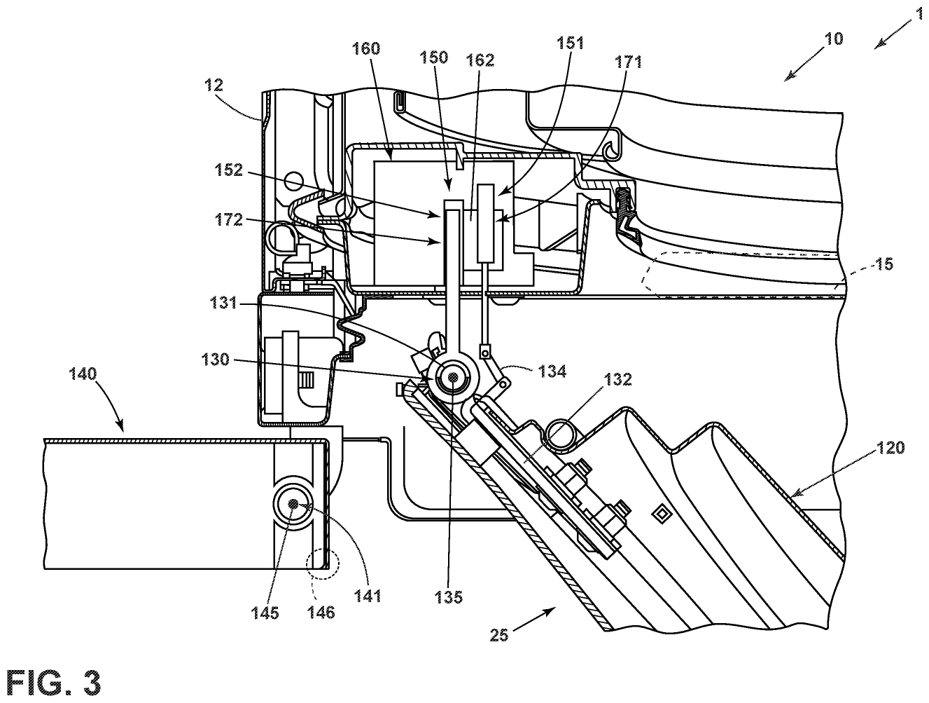

Referring now to FIG. 3, a portion of the chassis 12 and the door assembly 25 is illustrated in a top cross-sectional view. The chassis 12 can define an open face 15 as shown. In the illustrated example, the open face 15 is at least partially formed by the bellows 26 and the tub 14, though this need not be the case.

The door assembly 25 can include a door 120, which can be a functional door, selectively closing the open face 15. A hinge 130 can be mounted to the door 120. The hinge 130 can include a hinge pin 131 and a hinge plate 132, with the hinge plate 132 rotatable about the hinge pin 131. The hinge plate 132 can be mounted to the door 120 such that the door 120 co-rotates with the hinge plate 132.

The hinge 130 can also define a first rotation axis 135 as shown. The first rotation axis 135 is illustrated extending through the hinge pin 131. The door can be rotatable about the first rotation axis 135 such that the door 120 is movable between an open and closed position. The door 120 can close the open face 15 when in the closed position.

The door assembly 25 can also include an outer door 140, which can be an aesthetic door, and an outer hinge 141 mounted thereto. The outer door 140 can be positioned exteriorly of the door 120 with respect to the open face 15. The outer hinge 141 can be spaced from the hinge 130 and define an outer rotation axis 145. In the illustrated example, the outer door 140 is in a fully-open position.

It is contemplated that the outer door 140 and the door 120 can each freely rotate about the respective outer rotation axis 145 and first rotation axis 135. In the illustrated example, the door 120 can close the open face 15 adjacent the bellows 26, and the outer door 140 can close over the door 120 to form an exterior surface of the household appliance 1 (FIG. 1). In another example, the outer door 140 and the door 120 can be selectively coupled together such that they co-rotate at least about the respective outer rotation axis 145 and first rotation axis 135.

An actuator assembly 150 can be provided for movement of the door 120. The actuator assembly 150 can include a first actuator 151 and a second actuator 152. Either or both of the first actuator 151 or the second actuator 152 can be operably coupled to the hinge 130. In the example shown, the second actuator 152 is directly coupled to the hinge 130 though this need not be the case. In addition, a linkage 134 can be coupled to the hinge plate 132. The first actuator 151 can be coupled to the linkage 134. In this manner, the first actuator can be indirectly coupled to the hinge 130 by way of the linkage 134.

A hinge block 160 can be provided in the door assembly 25. The hinge block 160 can be positioned within or coupled to the chassis 12. The actuator assembly 150 can be mounted to the hinge block 160 as shown. In the non-limiting example shown, the first actuator 151 is arranged in parallel with the second actuator 152. It is understood that the first and second actuators 151, 152 can have any suitable arrangement.

The door assembly 25 is movable between a closed position, in which the door 120 closes the open face 15, and a fully-open position, in which the door 120 forms a maximum opening angle with the open face 15 as will be described below. It can be appreciated that when the outer door 140 and the door 120 are each in a fully-open position, the position of the fully-opened outer door 140 can limit a maximum opening angle of the door 120. For instance, if the door 120 were to be opened solely by rotation about the first rotation axis 135, the door 120 would contact a portion 146 of the outer door when fully opened.

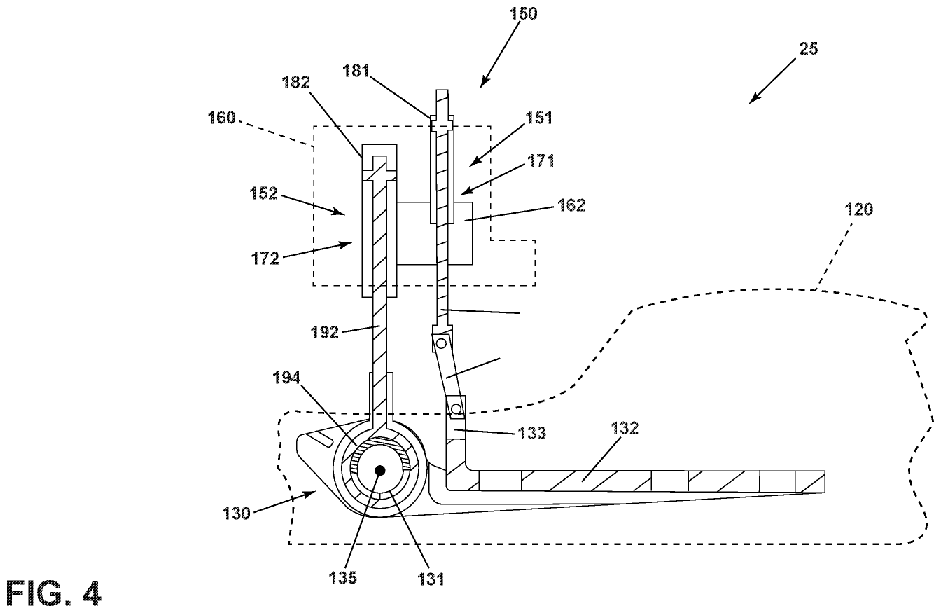

Turning to FIG. 4, a schematic view illustrates the door assembly 25 in a closed position. The door 120, the hinge 130 including the hinge pin 131 and hinge plate 132, the hinge block 160, and the actuator assembly 150 are illustrated in isolation from the chassis 12 (FIG. 3) for visual clarity. In addition, the hinge block 160 and the door 120 are illustrated in dashed line for visual clarity.

As described above, the hinge plate 132 is mounted to the door 120 such that the hinge plate 132 co-rotates with the door 120 about the hinge pin 131 and first rotation axis 135. In the example shown, with the hinge plate 132 and door 120 in the closed position, the door 120 closes the open face 15 (FIG. 3).

In addition, in the example shown, the first actuator 151 and the second actuator 152 are in the form of a respective first hydraulic cylinder 171 and a second hydraulic cylinder 172 though this need not be the case. Any suitable actuator can be provided, including a pneumatic actuator, electric actuator, linear actuator, rotary actuator, or the like, or combinations thereof. In some examples, the actuator assembly 150 can be coupled to the controller 106 (FIG. 1) such that the controller 106 can controllably operate the first and second actuators 151, 152, including for individual actuation, simultaneous actuation, or the like.

In the illustrated example of FIG. 4, the first hydraulic cylinder 171 and the second hydraulic cylinder 172 can include a respective first cylinder 181 and second cylinder 182, as well as a respective first piston 191 and second piston 192. The first and second cylinders 181, 182 can be mounted within the hinge block 160. Either or both of the first cylinder 181 or the second cylinder 182 can be movable within the hinge block 160. In the non-limiting example shown, the second cylinder 182 is fixedly mounted to the hinge block 160. A movable carrier plate 162 is provided within the hinge block 160 and coupled to the first cylinder 181. Thus, the carrier plate 162 and the first cylinder 181 can be movable within the hinge block 160 while the second cylinder 182 remains in place during rotation of the door 120.

The first piston 191 can extend from the first cylinder 181 and couple to the hinge plate 132. More specifically, an arm 133 can extend from the hinge plate 132, and the linkage 134 can be coupled between the first piston 191 and the arm 133 as shown.

The second piston 192 can extend from the second cylinder 182 and be coupled to the hinge pin 131. In the example shown, the second piston 192 includes a sleeve 194 that at least partially surrounds the hinge pin 131, wherein the hinge pin 131 can rotate within the sleeve 194.

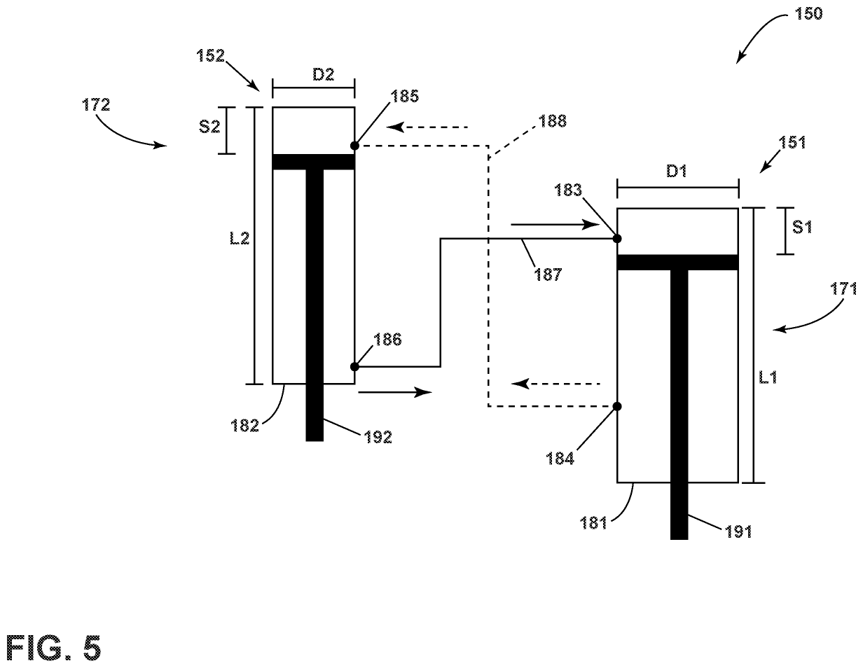

FIG. 5 illustrates the actuator assembly 150 with the first and second hydraulic cylinders 171, 172 in an exemplary arrangement. It is contemplated that the first and second hydraulic cylinders 171, 172 can be fluidly coupled such that actuation of the first hydraulic cylinder 171 generates a corresponding actuation of the second hydraulic cylinder 172.

An inlet 183 and an outlet 184 are provided with the first cylinder 181. An inlet 185 and an outlet 186 are provided with the second cylinder 182. A first fluid path 187 (illustrated in solid line) extends between the outlet 186 of the second cylinder 182 and the inlet 183 of the first cylinder 181. A second fluid path 188 (illustrated in dashed line) extends between the outlet 184 of the first cylinder 181 and the inlet 185 of the second cylinder 182.

The first hydraulic cylinder 171 and the second hydraulic cylinder 172 can define a respective first diameter D1 and second diameter D2, as well as a respective first length L1 and second length L2. A first stroke length S1 and a second stroke length S2 can also be defined for the respective first and second hydraulic cylinders 171, 172. As used herein, a “stroke length” of a hydraulic cylinder will refer to a maximum distance traveled by a piston of the hydraulic cylinder between a fully-retracted position to a fully-extended position of that piston. In one non-limiting example, the first stroke length S1 can be 35 mm and the second stroke length S2 can be 40 mm. In other non-limiting examples, the first stroke length S1 or second stroke length S2 can be in a range between 10-200 mm. In still other non-limiting examples, the first stroke length S1 can be between 0.1-10 times the second stroke length S2.

In addition, a length-to-diameter ratio of each hydraulic cylinder 171, 172 can be selected, modified, or the like to provide a desired stroke length for each piston 191, 192. In a non-limiting example, the first length L1 can be between 0.1-10 times the first diameter D1. In another non-limiting example, the second length L2 can be between 0.1-10 times the second diameter D2. It can be appreciated that the length-to-diameter ratios L1/D1 and L2/D2 for the respective first and second hydraulic cylinders 171, 172 can be selected to form a predetermined ratio of the stroke lengths S1/S2.

During operation of the actuator assembly 150, as the first piston 191 is drawn out of the first cylinder 181, fluid is directed along the second fluid path 188 from the first cylinder 181 into the second cylinder 182 (illustrated with dashed arrows). The added fluid pressure causes the second piston 192 to move out of the second cylinder 182. Such a change in position of the second piston 192 causes fluid to move along the first fluid path 187 and into the first cylinder 181 (illustrated with solid arrows). Thus, actuation of the first actuator 151, e.g. by pulling or drawing the first piston 191 out of the first cylinder 181, can automatically generate a corresponding actuation of the second actuator 152, e.g. motion of the second piston 192 out of the second cylinder 182. In this manner, the first hydraulic cylinder 171 can form a “leader” cylinder and the second hydraulic cylinder 172 can form a “follower” cylinder.

It is also understood that retraction of the first piston 191 into the first cylinder 181 can cause or generate a corresponding retraction of the second piston 192 into the second cylinder 182. Thus, the first and second hydraulic cylinders 171, 172 can be double-acting hydraulic cylinders configured to extend or retract during operation.

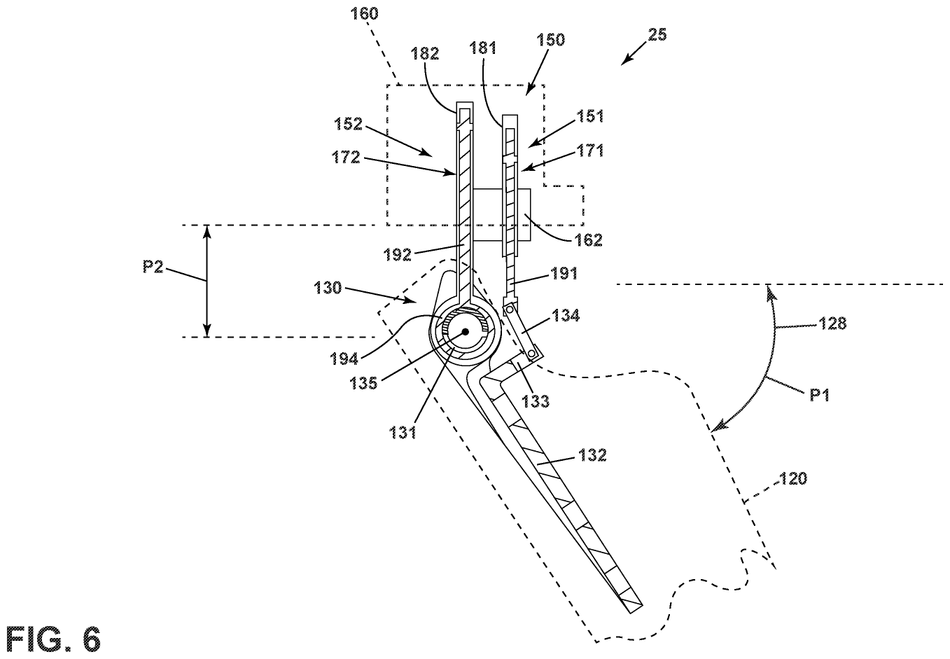

Turning to FIG. 6, the door assembly 25 is shown in an intermediate position with the door 120 partially opened. As the door 120 is opened, the actuator assembly 150 can exert multiple forces upon the hinge 130 such that the hinge 130 can move along multiple motion paths. In some examples, the hinge 130 can move along multiple motion paths simultaneously to form a combined or net motion path. In some examples, the hinge 130 can sequentially move along multiple motion paths.

In the illustrated example, opening of the door 120 causes the carrier plate 162 and second actuator 151 to shift outwardly and at least partially out of the hinge block 160. The first actuator 151 can remain in place within the hinge block 160.

In addition, in the illustrated example, opening of the door 120 causes the first piston 191 to move out of the first cylinder 181 by way of the linkage 134. Such motion of the first piston 191 causes rotation of the hinge plate 132 about the first rotation axis 135, defining a first motion path P1. It is understood that the hinge plate 132 and the door 120 can co-rotate such that the door 120 is also rotated along the first motion path P1. In this manner, the first motion path P1 can form a rotational motion path to rotate the door 120 about the first rotation axis 135.

An opening angle 128 can also be defined for the door 120 along the first motion path P1. The opening angle 128 at any position of the door 120 can be defined with respect to the closed position (FIG. 4) of the door 120. The opening angle 128 can be between 0-180°, including between 0-160°, including between 0-150°, including between 0-135°, in some non-limiting examples.

Motion of the first piston 191 also generates corresponding motion of the second piston 192 out of the second cylinder 182 by way of the fluid coupling between the first and second cylinders 181, 182 as described above. As the second piston 192 moves out of the second cylinder 182, the sleeve 194 causes the hinge pin 131 to move along a second motion path P2. In the example shown, the second motion path P2 forms a translational motion path along a linear direction. The second motion path P2 is perpendicular to the open face 15 in the example shown. It is understood that the hinge pin 131 and the door 120 can move together along the second motion path P2. In this manner, the hinge 130 can be movable along the second motion path P2 when the door 120 is rotated about the first rotation axis 135.

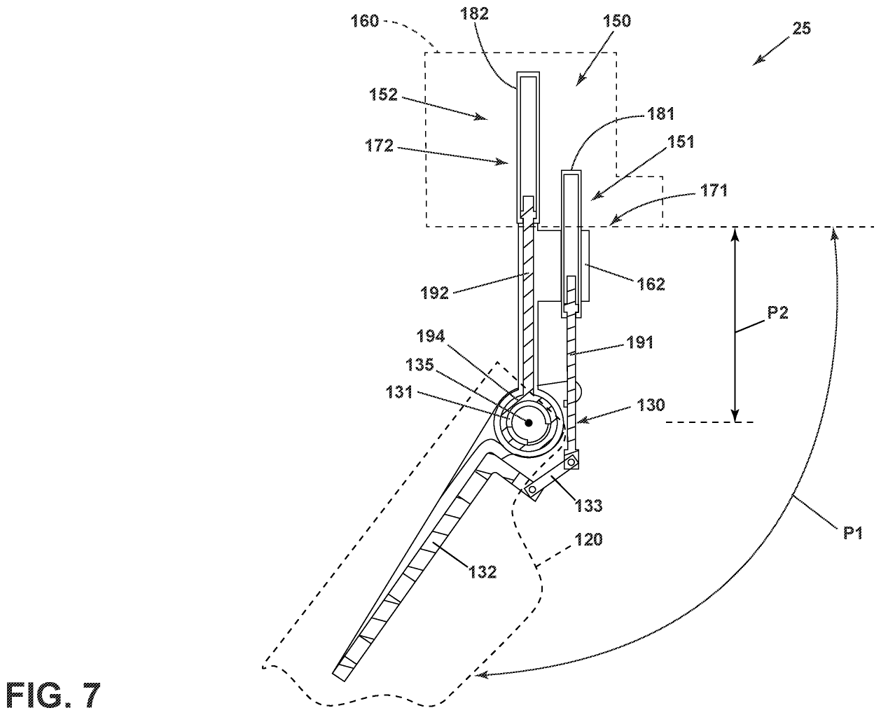

FIG. 7 illustrates the door assembly 25 in the fully-open position. As shown, the carrier plate 162 can form a maximum-shifted position outside of the hinge block 160, the first piston 191 can form a fully-extended position from the first cylinder 181, and the second piston 192 can form a fully-extended position from the second cylinder 182.

In this manner, the first actuator 151 can be operable between a first position, e.g. the retracted position as shown in FIG. 4, and a second position, e.g. the fully-extended position shown in FIG. 7, to rotate the door 120 about the first rotation axis 135. The second actuator 152 can be operable between a non-translated position, e.g. the retracted position shown in FIG. 4, and a translated position, e.g. the fully-extended position shown in FIG. 7. In the translated position, the hinge 130 can be translated away from the chassis 12 (FIG. 3). Thus, the actuator assembly 150 can define a rotational motion path (e.g. the first motion path P1) to rotate the door 120 about the first rotation axis 135, and can also define a translational motion path (e.g. the second motion path P2) to shift the first motion path P1 in a linear direction. The first actuator 171 acting upon the hinge plate 132 can form the first motion path P1, and the second actuator 172 acting upon the hinge pin 131 can form the second motion path P2 as shown.

Thus, the door 120 and hinge 130 can be shifted with respect to the outer door 140 (FIG. 3), and away from the chassis 12 (FIG. 3), providing for a wider opening angle and improved access to the interior. In some implementations, the door 120 and hinge 130 can be shifted in a combined motion path that includes movement directly away from the chassis 12 and also a lateral shift along the chassis 12 (FIG. 3), to provide for wider opening angles and avoid impingement with the outer door 140 (FIG. 3).

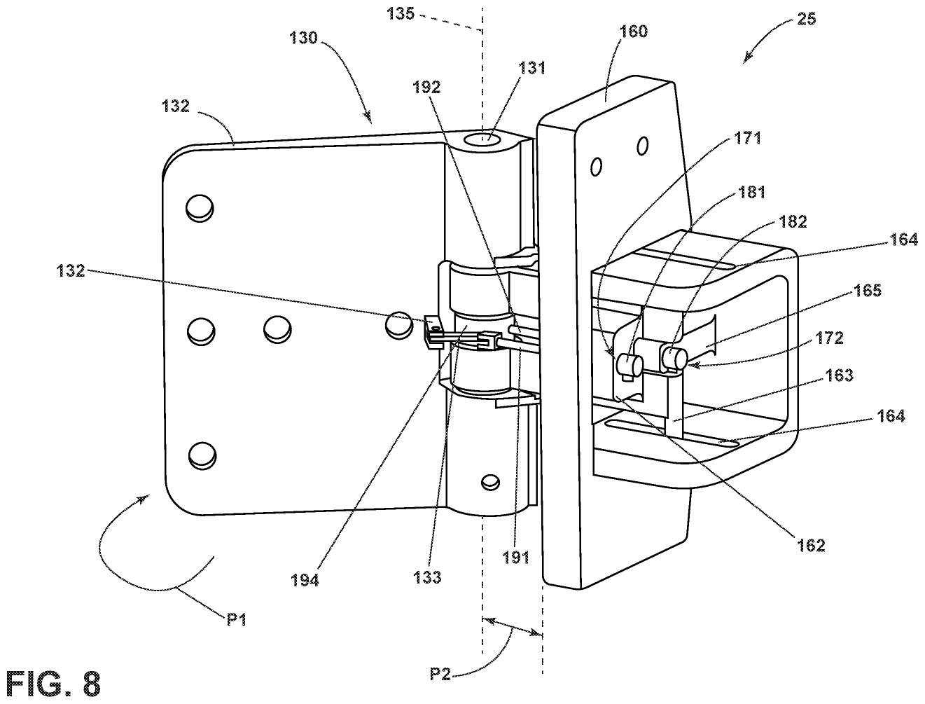

FIG. 8 illustrates a perspective view of the door assembly 25 in the intermediate position shown in FIG. 6. For visual clarity, the door 120 is not illustrated.

The hinge block 160 can include a movable arm 163 and a pair of guide slots 164. The carrier plate 162 can be coupled to the movable arm 163 for motion with respect to the hinge block 160. Rotation of the hinge plate 132 can cause actuation of the first hydraulic cylinder 171 and corresponding sliding of the movable arm 163 and carrier plate 162 along the guide slots 164.

In addition, the sleeve 194 can be coupled to a center of the hinge pin 131 as shown. Motion of the second hydraulic cylinder 172 can exert a non-rotational force on the center of the hinge pin 131 to shift the hinge 130 in a linear direction along the second motion path P2.

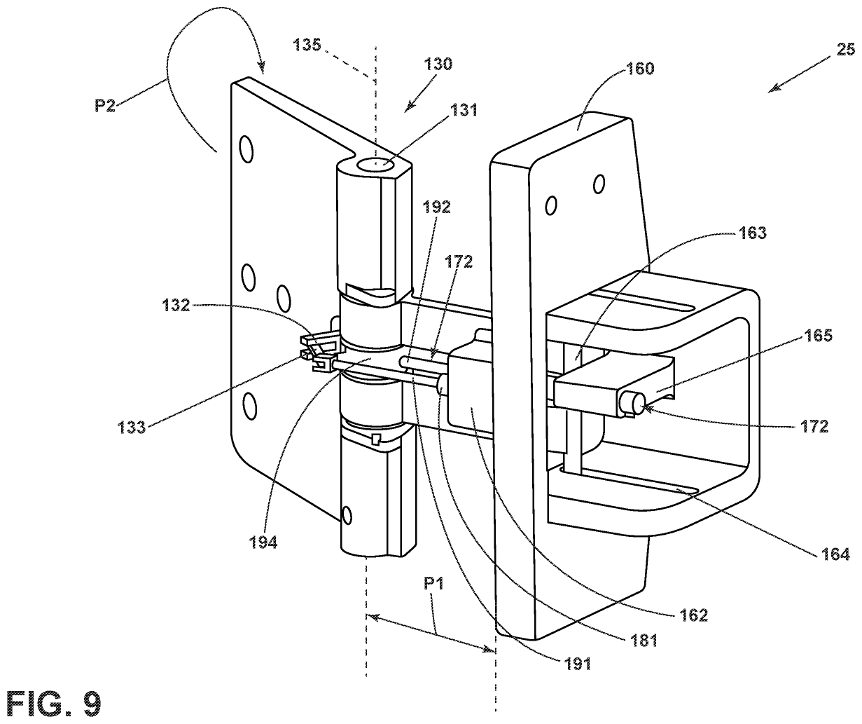

FIG. 9 illustrates a perspective view of the door assembly 25 in the fully-open position shown in FIG. 7, with the door 120 removed for clarity. A mounting arm 165 is shown within the hinge block 160. The first hydraulic cylinder 171 can be coupled to the mounting arm 165 as shown. As the hinge plate 132 is rotated, the carrier plate 162 and second hydraulic cylinder 172 can slide with the movable arm 163, while the first hydraulic cylinder 171 remains in a fixed position on the mounting arm 165.

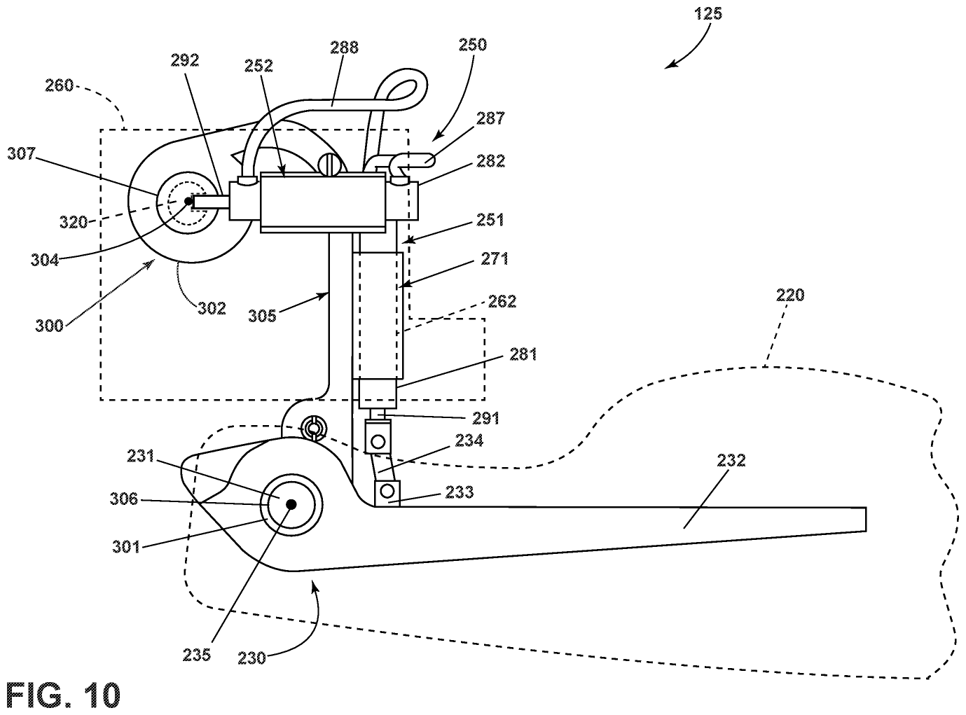

Referring now to FIG. 10, another door assembly 125 is shown that can be utilized in the household appliance 1, including the combination washing and drying machine 10 (FIG. 1). The door assembly 125 is similar to the door assembly 25; therefore, like parts will be identified with like numerals increased by 100, with it being understood that the description of the like parts of the door assembly 25 applies to the door assembly 125, except where noted.

The door assembly 125 includes a door 220, a hinge 230, a hinge pin 231, a hinge plate 232 with an arm 233, a linkage 234, a hinge block 260, a carrier plate 262, and an actuator assembly 250. The door assembly 125 is illustrated in isolation from the chassis 12 (FIG. 3) for visual clarity. In addition, the hinge block 260 and the door 220 are illustrated in dashed line for visual clarity.

The actuator assembly 250 can include a first actuator 251 and a second actuator 252. Either or both of the first actuator 251 or the second actuator 252 can be movable within the hinge block 260. One difference compared to the door assembly 25 is that the first and second actuators 251, 252 can be arranged perpendicular to one another. In the example shown, the first actuator 251 is coupled to the carrier plate 262 and the second actuator 252 is mounted to the hinge block 260 in a fixed position and perpendicular to the first actuator 271.

In addition, in the example shown, the first actuator 251 and the second actuator 252 are in the form of a first hydraulic cylinder 271 and a second hydraulic cylinder 272 though this need not be the case. Any suitable actuator can be provided, including a pneumatic actuator, electric actuator, linear actuator, rotary actuator, or the like, or combinations thereof. In some examples, the actuator assembly 250 can be coupled to the controller 106 (FIG. 1) such that the controller 106 can controllably operate the first and second actuators 251, 252, including for individual actuation, simultaneous actuation, or the like.

The first hydraulic cylinder 271 and the second hydraulic cylinder 272 can include a respective first cylinder 281 and second cylinder 282, as well as a respective first piston 291 and second piston 292. The first and second cylinders 281, 282 can be mounted within the hinge block 260. In addition, a first fluid path 287 and a second fluid path 288 can be provided for fluidly coupling the first hydraulic cylinder 271 and the second hydraulic cylinder 272.

In the illustrated example with the door assembly 125 in the closed position, the second piston 292 extends out of a left-side portion of the second cylinder 282 as shown. Another difference compared to the door assembly 25 is that an actuator lock 320 (illustrated in dashed line) can be provided with the hinge block 260. The actuator lock 320 can include a portion receiving the second piston 292 and preventing or blocking further extension of the second piston 292 toward the actuator lock 320.

Still another difference compared to the door assembly 25 is that a rotatable linkage 300 can be provided in the door assembly 125. The rotatable linkage 300 can include a body 305 with a first end 301 and a second end 302 as shown. A first aperture 306 can be provided at the first end 301. A second aperture 307 can be provided at the second end 302. The first aperture 306 can receive the hinge pin 231.

A second rotation axis 304 can be defined by the second aperture 307 as shown. The second aperture 307 can be mounted to the hinge block 260 (FIG. 10) such that the rotatable linkage 300 can rotate about the second rotation axis 304 with respect to the hinge block 260. The rotatable linkage 300 can also be coupled to the carrier plate 262. Thus, rotation of the rotatable linkage 300 can cause corresponding rotation of the second hydraulic cylinder 272 by way of the carrier plate 262.

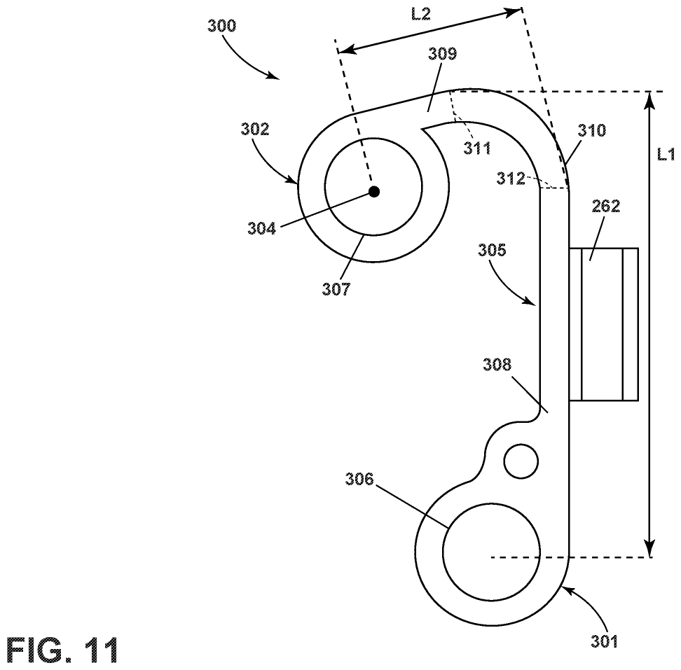

FIG. 11 illustrates the rotatable linkage 300 and carrier plate 262 in isolation. The body 305 of the rotatable linkage 300 can have a generally C-shaped profile. More specifically, the body 305 can include a first portion 308, a second portion 309, and a curved portion 310 extending between the first and second portions 308, 309. The curved portion 310 can extend between a first end 311 and a second end 312 as shown.

A first length L1 can be defined along the first portion 308 between the center of the first aperture 306 and the first end 311 of the curved portion 310. A second length L2 can be defined along the second portion 309 between the center of the second aperture 307 and the second end 312 of the curved portion 310. In a non-limiting example, the first length L1 can be between 0.2-5 times the second length L2.

In addition, the carrier plate 262 can be provided with the rotatable linkage 300. The carrier plate 262 can be a distinct component and mounted to the rotatable linkage 300 in some examples, or the carrier plate 262 can be unitarily formed with the rotatable linkage 300 in some examples. The carrier plate 262 can be coupled to the body 305 between the first end 301 and the second end 302 as shown.

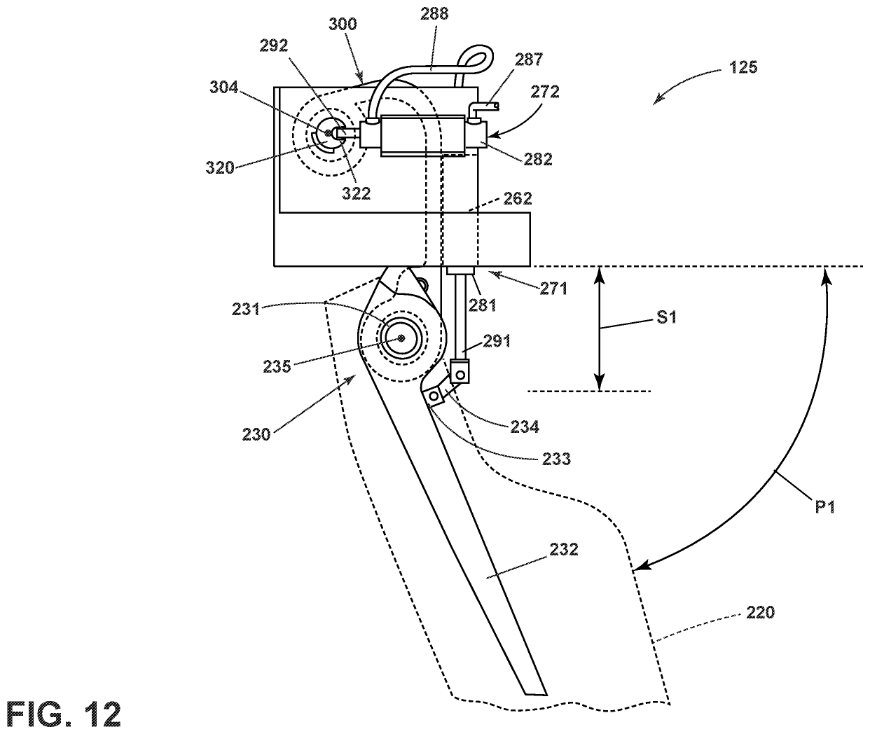

Turning to FIG. 12, the door assembly 125 is illustrated in an intermediate position with the door 220 partially opened. As the door 220 is moved from the closed position of FIG. 11 to the intermediate position shown in FIG. 12, the rotatable linkage 300, carrier plate 262, and first cylinder 281 can remain stationary. In addition, in the example shown, the first piston 291 is moved to a maximally-extended position to form a first stroke length S1.

The actuator lock 320 and the second piston 292 can also remain stationary between the closed position of FIG. 11 and the intermediate position of FIG. 12. The actuator lock 320 can further include a body with a recess 322 receiving the second piston 292. The recess 322 can be formed to a predetermined depth, thereby limiting extension of the second piston 292 in a direction toward the actuator lock 320 as described above.

Opening of the door 220 causes the first piston 291 to be drawn out of the first cylinder 281. As the door 220 is opened, the actuator assembly 250 can exert multiple forces upon the hinge 230 such that the hinge 230 can move along multiple motion paths. In some examples, the hinge 230 can move along multiple motion paths simultaneously to form a combined or net motion path. In some examples, the hinge 230 can sequentially move along multiple motion paths.

The first hydraulic cylinder 271 can exert a force on the hinge plate 232 by way of the linkage 234 to form a first motion path P1 for the hinge 230. It is understood that the door 220 also travels along the first motion path P1 with the hinge plate 232. Thus, the first motion path P1 can be a rotational motion path to rotate the door 120 about the first rotation axis 235.

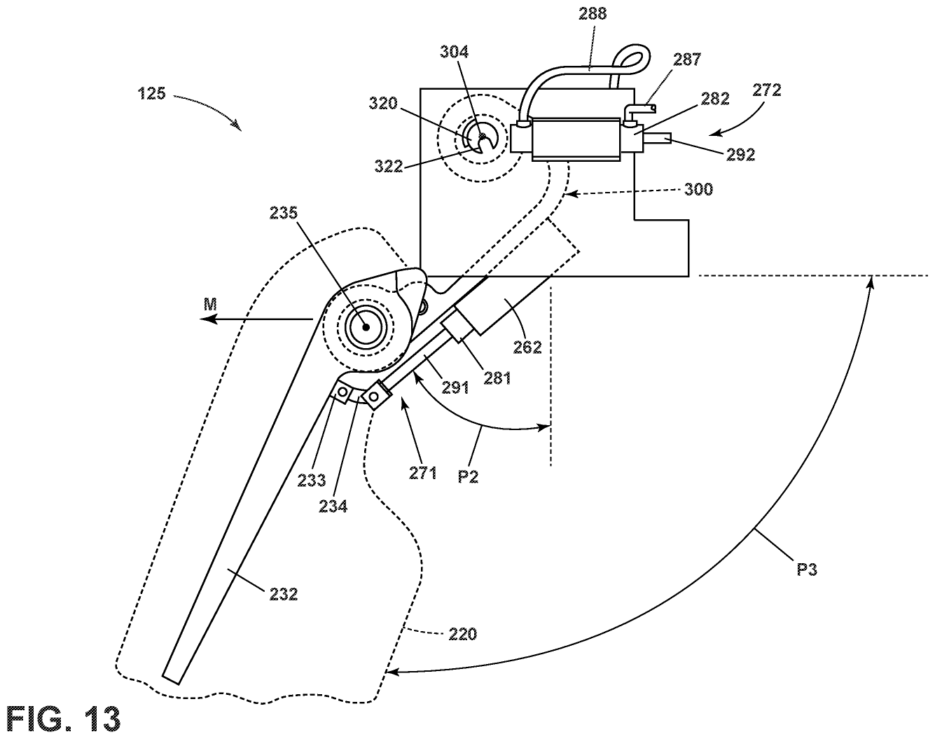

As the door 220 is opened beyond the intermediate position shown in FIG. 12, the rotatable linkage 300 and carrier plate 262 can begin to rotate about the second rotation axis 304 within the hinge block 260. Turning to FIG. 13, a fully-open position of the door assembly 125 is shown. In this position, the first piston 291 remains fully extended from the first cylinder 281. The rotatable linkage 300 has been rotated about the second rotation axis 304, along with the carrier plate 262, first cylinder 281, and first piston 291.

Rotation of the rotatable linkage 300 can cause the second piston 292 to move out of the actuator lock 320 as shown. The actuator lock 320 can rotate with the rotatable linkage 300 such that the recess 322 is unaligned with the second piston 292. It is understood that closing of the door can provide for re-alignment and engagement of the recess 322 with the second piston 292.

The hinge 230, including the hinge pin 231 and hinge plate 232, is also rotated about the second rotation axis 304 to define a second motion path P2 as shown. An overall motion path P3 is illustrated for the door assembly 125 which combines the first motion path P1 (FIG. 12) and the second motion path P2. It can be seen that the overall motion path P3 provides at least lateral motion M (indicated with an arrow) for the door 220 and hinge 230, such that the hinge 230 can be shifted laterally along the chassis 12 (FIG. 3) when the door 220 is opened. Thus, the actuator assembly 250 can provide sequential motion paths for the door 220 and hinge 230, whereby the first motion path P1 is followed by the second motion path P2 to form the overall motion path P3. In this manner, the first actuator 251 can be operable between a first position, e.g. the retracted position as shown in FIG. 10, and a second position, e.g. the fully-extended position shown in FIG. 13, to rotate the door 220 about the first rotation axis 235. The second actuator 152 can be operable between a non-translated position, e.g. the retracted position shown in FIG. 10, and a translated position, e.g. the fully-extended position shown in FIG. 13. In the translated position, the hinge 230 can be translated at least laterally along the chassis 12 (FIG. 3).

Thus, the door 220 and hinge 230 can be shifted with respect to the outer door 140 (FIG. 3), and at least laterally along the chassis 12 (FIG. 3), providing for a wider opening angle and improved access to the interior. In some implementations, the door 220 and hinge 230 can be shifted in a combined motion path that includes movement directly away from the chassis 12 and also a lateral shift along the chassis 12 (FIG. 3), to provide for wider opening angles and avoid impingement with the outer door 140 (FIG. 3).

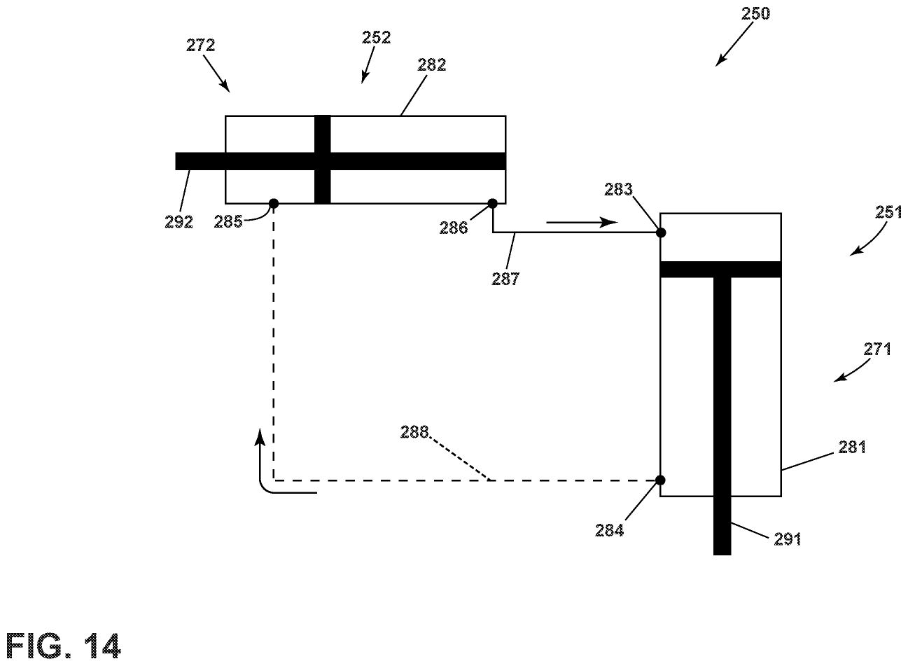

FIG. 14 illustrates the actuator assembly 250 with the first and second hydraulic cylinders 271, 272 in the perpendicular arrangement as shown in FIGS. 10-13. It is contemplated that the first and second hydraulic cylinders 271, 272 can be fluidly coupled such that actuation of the first hydraulic cylinder 271 generates a corresponding actuation of the second hydraulic cylinder 272.

An inlet 283 and an outlet 284 are provided with the first cylinder 181. An inlet 285 and an outlet 286 are provided with the second cylinder 182. The first fluid path 287 (illustrated in solid line) extends between the outlet 286 of the second cylinder 282 and the inlet 283 of the first cylinder 281. The second fluid path 288 (illustrated in dashed line) extends between the outlet 284 of the first cylinder 281 and the inlet 285 of the second cylinder 282.

As the first piston 291 is drawn out of the first cylinder 181, fluid is directed along the second fluid path 288 into the second cylinder 282. The added fluid pressure causes the second piston 292 to move to the right within the second cylinder 282, and also causes fluid to move along the first fluid path 287 into the first cylinder 281. Thus, the first hydraulic cylinder 271 can form a “leader” cylinder and the second hydraulic cylinder 272 can form a “follower” cylinder.

One difference is that the second piston 292 can be configured to extend or retract out of both sides of the second cylinder 282. For example, when the first piston 291 is fully retracted, the second piston 292 can extend from the left side of the second cylinder 282 (see FIG. 10). As the first piston 291 is pulled outward, the second piston 292 can move to the right and extend out of the right side of the second cylinder 282 (see FIG. 13).

The described aspects of the present disclosure provide for a variety of benefits. The actuator assembly exerting multiple forces on multiple portions of the hinge or the door provides for a combined motion path, including a rotational component and a translational component, that increases a maximum opening angle of the door for improved access. The leader/follower cylinder arrangement provides for a smooth, assisted opening action wherein user rotation of the door generates automatic translational movement from the actuator assembly. Regardless of the type of actuator used, the disclosed actuator assembly can shift the inner door hinge away from the outer door such that the inner door has a wider range of motion compared to traditional paired-door assemblies. The disclosed actuator assembly can also shift the inner door hinge back into the chassis as the door is closed, providing for an improved aesthetic appearance with the outer door fully hiding or overlying the inner door when closed.

In addition, the disclosed actuator lock can provide for a limit on actuator travel once the door is closed, leading to improved stability in the door assembly. Further, the relative size or dimensions of the actuators, e.g. the length-to-diameter ratio of the hydraulic cylinders or a ratio of stroke lengths, can be selected to accommodate a variety of outer-door hinge dimensions when shifting the inner door hinge, e.g. larger or smaller lateral motion as the door is opened, which provides a simplified hinge assembly across multiple appliances.

To the extent not already described, the different features and structures of the various aspects can be used in combination with each other as desired, or can be used separately. That one feature can not be illustrated in all of the aspects is not meant to be construed that it cannot be, but is done for brevity of description. Thus, the various features of the different aspects can be mixed and matched as desired to form new aspects, whether or not the new aspects are expressly described.

While the present disclosure has been specifically described in connection with certain specific aspects thereof, it is to be understood that this is by way of illustration and not of limitation. Reasonable variation and modification are possible within the scope of the forgoing disclosure and drawings without departing from the spirit of the present disclosure. Hence, specific dimensions and other physical characteristics relating to the aspects disclosed herein are not to be considered as limiting, unless expressly stated otherwise.

What is claimed is:

1. A door assembly for closing an open face defined by a chassis, the door assembly comprising:
a door selectively closing the open face;
a hinge mounted to the door and defining a first rotation axis;
a first actuator operably coupled to the hinge and defining a rotational motion path to rotate the door about the first rotation axis; and
a second actuator operably coupled to the hinge and defining a translational motion path, wherein the hinge is movable along the translational motion path when the door is rotated about the first rotation axis.

2. The door assembly of claim 1, wherein the translational motion path is perpendicular to the open face.

3. The door assembly of claim 1, wherein the translational motion path is at least partially parallel to the open face.

4. The door assembly of claim 1, wherein the first actuator comprises a first hydraulic cylinder and the second actuator comprises a second hydraulic cylinder.

5. The door assembly of claim 4, wherein the first hydraulic cylinder is fluidly coupled to the second hydraulic cylinder such that actuation of the first hydraulic cylinder generates corresponding actuation of the second hydraulic cylinder.

6. The door assembly of claim 4, wherein the first hydraulic cylinder defines a first diameter, and the second hydraulic cylinder defines a second diameter, wherein the first diameter is between 0.1-10 times the second diameter.

7. The door assembly of claim 4, further comprising a rotatable linkage coupled to the second hydraulic cylinder and to the hinge.

8. The door assembly of claim 7, wherein the rotatable linkage defines a second rotation axis, and wherein the second hydraulic cylinder is rotatable about the second rotation axis to shift the door along the translational motion path.

9. The door assembly of claim 1, wherein at least one of the first actuator or the second actuator is directly coupled to the hinge.

10. The door assembly of claim 1, further comprising a hinge block coupled to the chassis, wherein the first actuator and the second actuator are mounted to the hinge block.

11. The door assembly of claim 1, further comprising an opening angle of the door defined with respect to a closed position of the door, wherein the opening angle is between 0-135°.

12. The door assembly of claim 1, further comprising an outer door and an outer hinge mounted to the outer door, the outer hinge defining an outer rotation axis parallel to the first rotation axis.

13. The door assembly of claim 12, wherein the door and the outer door are each freely rotatable about the respective first rotation axis and outer rotation axis, with the outer door positioned exteriorly of the door with respect to the open face.

14. A household appliance, comprising:
a chassis defining an interior with an open face; and
a door assembly coupled to the chassis and comprising:
a door movable between open and closed positions, with the door closing the open face when in the closed position;
a first rotation axis defined along the door; and
an actuator assembly operably coupled to the door, the actuator assembly defining a rotational motion path to rotate the door about the first rotation axis, and also defining a translational motion path to shift the rotational motion path in at least a linear direction.

15. The household appliance of claim 14, wherein the actuator assembly comprises a first hydraulic cylinder and a second hydraulic cylinder.

16. The household appliance of claim 15, wherein the first hydraulic cylinder at least partially forms the rotational motion path.

17. The household appliance of claim 15, wherein the first hydraulic cylinder is fluidly coupled to the second hydraulic cylinder such that actuation of the first hydraulic cylinder generates corresponding actuation of the second hydraulic cylinder.

18. A household appliance, comprising:
a chassis defining an interior with an open face;
a door selectively closing the open face;
a hinge mounted to the door and defining a rotation axis;
a first actuator operably coupled to the hinge and operable between first and second positions to rotate the door about the rotation axis; and
a second actuator operably coupled to the hinge and operable between non-translated and translated positions, where, in the translated position, the hinge is translated at least one of laterally or away from the chassis.

19. The household appliance of claim 18, wherein the first actuator comprises a first hydraulic cylinder with a first piston forming the first and second positions.

20. The household appliance of claim 18, wherein the second actuator comprises a second hydraulic cylinder with a second piston forming the non-translated and translated positions.
